(19) United States
(12) Patent Application Publication
(10) Pub. No.: US 2009/0129467 A1
(43) Pub. Date: May 21, 2009

(54) Method for Encoding at Least One Digital Picture, Encoder, Computer Program Product

(75) Inventors: Zhengguo LI, Singapore (SG); Wei Yao, Singapore (SG); Keng Pang Lim, Singapore (SG); Xiao Lin, Singapore (SG); Susanto Rahardja, Singapore (SG)

Correspondence Address: CROCKETT & CROCKETT, P.C., 26020 ACERO, SUITE 200, MISSION VIEJO, CA, 92691, US

(73) Assignee: AGENCY FOR SCIENCE, TECHNOLOGY AND RESEARCH, Singapore (SG)

(21) Appl. No.: 11/910,853

(22) PCT Filed: Apr. 6, 2006
(86) PCT No.: PCT/SG2006/000089

§ 371 Date: Jan. 9, 2009

Related U.S. Application Data
(60) Provisional application No. 60/669,531, filed on Apr. 8, 2005.

(51) Int. Cl. H04N 7/32

(52) U.S. Cl. 375/240.12; 375/E07.243

(57) ABSTRACT

A method for encoding at least one digital picture is described, wherein a first representation of the picture is generated, a second representation of the picture is generated and a third representation of the picture is generated from the first representation of the picture and the second representation of the picture by predicting the coding information of the picture elements of the picture using the first representation of the picture and the second representation of the picture.

### BACKGROUND

The invention relates to a method for encoding at least one digital picture, an encoder and a computer program product.

In course of the standardization works of the MPEG (Moving Pictures Expert Group) a method for scalable video coding (SVC) was proposed which is based on open-loop motion estimation/motion compensation (ME/MC), and is an scalable extension of the video coding standard AVC, see [1] and [2].

Besides the ME/MC scheme available in AVC [2], key parts of the proposed SVC method are inter-layer prediction schemes.

For each slice at the enhancement layer, a corresponding “base layer” (specified by the parameter base_id_plus1, see [1]) is chosen to remove the redundancy between the motion information and the residual information at the “base layer” and those at the enhancement layer, respectively.

Since there is only one base layer for each slice at an enhancement layer (see [1]), the coding efficiency may be low in certain cases.

FIG. 1 shows an example for coding layers according to prior art.

In FIG. 1, four layers are illustrated, a first layer, denoted by (QCIF, Low), a second layer denoted by (QCIF, Medium), a third layer denoted by (CIF, Low) and a fourth layer denoted by (CIF, Medium).

“Low” indicates that the corresponding layer comprises coding information quantized with an accuracy lower than a layer with corresponding to “Medium”. This is also illustrated by a first axis 105, indicating that a layer shown farther to the right in FIG. 1 corresponds to coding information with higher SNR.

“QCIF” (quarter common intermediate format) indicates that the corresponding layer comprises coding information for a lower spatial resolution than a layer corresponding to “CIF” (common intermediate format). This is also illustrated by a second axis 106, indicating that a layer shown farther to the top in FIG. 1 corresponds to coding information with higher resolution.

According to prior art, an overall base layer is chosen as the first layer 101 (QCIF, Low), which is also the “base layer” for all slices at both the third layer 103 (CIF, Low) and the second layer 102 (QCIF, Medium).

When a scalable bit-stream is generated, the spatial redundancy between the third layer 103 (CIF, Low) and the first layer 101 (QCIF, Low) and the SNR (signal-to-noise) redundancy between the first layer 101 (QCIF, Low) and the second layer 102 (QCIF, Medium) can be removed by the inter-layer prediction schemes proposed in the working draft [1].

However, there is a problem when the fourth layer 104 (CIF, Medium) is coded. Since there is only one “base layer” for each slice, either the third layer 103 (CIF, Low) or the first layer 101 (QCIF, Medium) is chosen as the “base layer”.

On one hand, when the first layer 101 (CIF, Low) is chosen as the “base layer”, the SNR redundancy between the first layer 101 (CIF, Low) and the second layer 102 (CIF, Medium) can be efficiently removed.

However, the spatial redundancy between the second layer 102 (CIF, Medium) and the fourth layer 104 (QCIF, Medium) cannot be removed.

On the other hand, when the second layer 102 (QCIF, Medium) is chosen as the “base layer”, the spatial redundancy between the second layer 102 (QCIF, Medium) and the fourth layer 104 (CIF, Medium) can be efficiently removed. However, the SNR redundancy between the fourth layer 104 (CIF, Medium) and the third layer 103 (CIF, Low) cannot be removed.

There are two ways to address this problem:

1)
the first layer 101 (QCIF, Low) is set as “base layer” of the second layer 102 (QCIF, Medium)
the first layer 101 (QCIF, Low) is set as “base layer” of the third layer 103 (CIF, Low)
the third layer 103 (CIF, Low) is set as “base layer” of the fourth layer 104 (CIF, Medium)

In this case, as discussed above, the coding efficiency of the fourth layer (CIF, Medium) cannot be guaranteed.

2)
the first layer 101 (QCIF, Low) is set as “base layer” of the second layer 102 (QCIF, Medium)
the second layer 102 (QCIF, Medium) is set as “base layer” of the third layer 103 (CIF, Low)
the third layer 103 (CIF, Low) is set as “base layer” of the fourth layer 104 (CIF, Medium)

In this case, the coding efficiency of the fourth layer 104 (CIF, Medium) can be guaranteed. However, the coding efficiency of the third layer 103 (CIF, Low) in the case that the second layer 102 (QCIF, Medium) is its “base layer” is lower that in the case that the first layer 101 (QCIF, Low) is its “base layer”. The gap will be more than 2 dB when the gap between the quality indicated by “low” at the resolution indicated by “CIF” and the quality indicated by “medium” at the resolution indicated by “QCIF” is large.

An object of the invention is to provide an enhanced encoding method for digital pictures compared to the encoding methods according to prior art.

### SUMMARY OF THE INVENTION

The object is achieved by a method for encoding at least one digital picture, an encoder and a computer program product with the features according to the independent claims.

A method for encoding at least one digital picture is provided wherein a first representation of the picture is generated, a second representation of the picture is generated and a third representation of the picture is generated from the first representation of the picture and the second representation of the picture by predicting the coding information of the picture elements of the picture using the first representation of the picture and the second representation of the picture.

Further, an encoder and a computer program product according to the method for encoding at least one digital picture described above are provided.

Illustrative embodiments of the invention are explained below with reference to the drawings.

### BRIEF DESCRIPTION OF THE DRAWINGS

FIG. 1 shows an example for coding layers according to prior art.

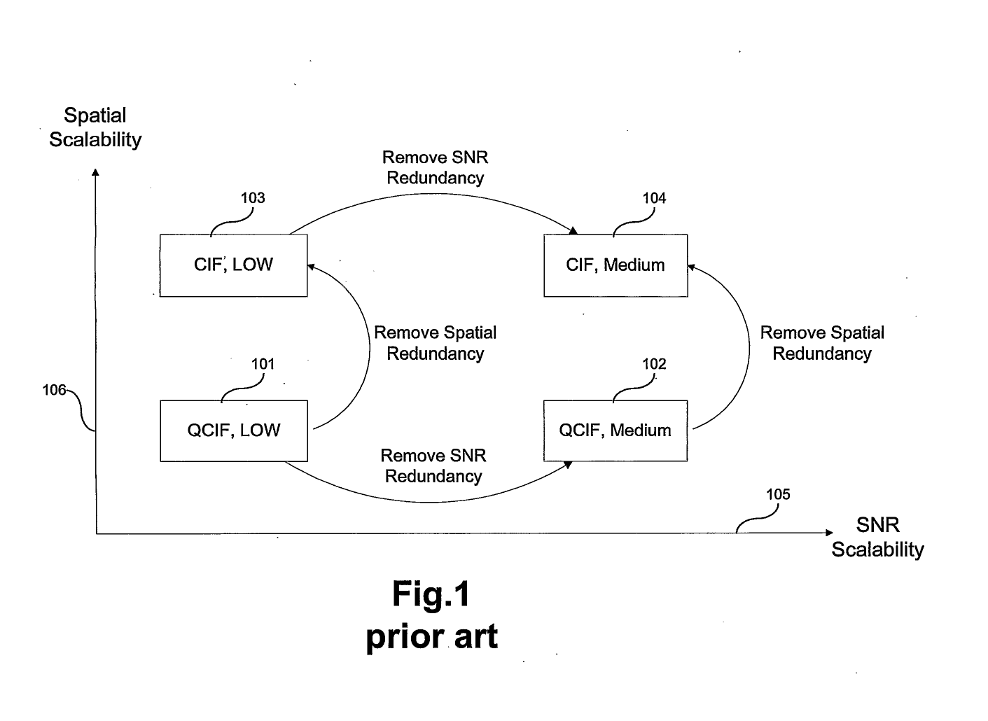

FIG. 2 shows an encoder according to an embodiment of the invention.

FIG. 3 shows a decoder according to an embodiment of the invention.

### DETAILED DESCRIPTION

Illustratively, a prediction scheme with two “base layers” is used, while both (in one embodiment the layers (QCIF, Medium) and (CIF, Low) as mentioned above) are the base layers for each slice at (CIF, Medium). In other words, there are two base layers for each slice at (CIF, Medium). The scheme is given in detail below.

Coding information assigned to picture elements is for example chrominance information order luminance information.

The picture to be encoded can be one picture of a plurality of pictures, i.e. one frame of a video sequence and the first representation and the second representation can be generated using motion compensation.

The embodiments which are described in the context of the method for encoding at least one digital picture are analogously valid for the encoder and the computer program product.

In one embodiment, the second representation of the picture has a lower signal-to-noise ratio than the first representation.

In one embodiment, the second representation of the picture has a higher resolution than the first representation.

The second representation is for example generated such that it has the resolution according to the CIF (common intermediate format), the first representation is for example generated such that it has the resolution according to the QCIF (quarter common intermediate format) and the third representation is for example generated such that it has the resolution according to the CIF.

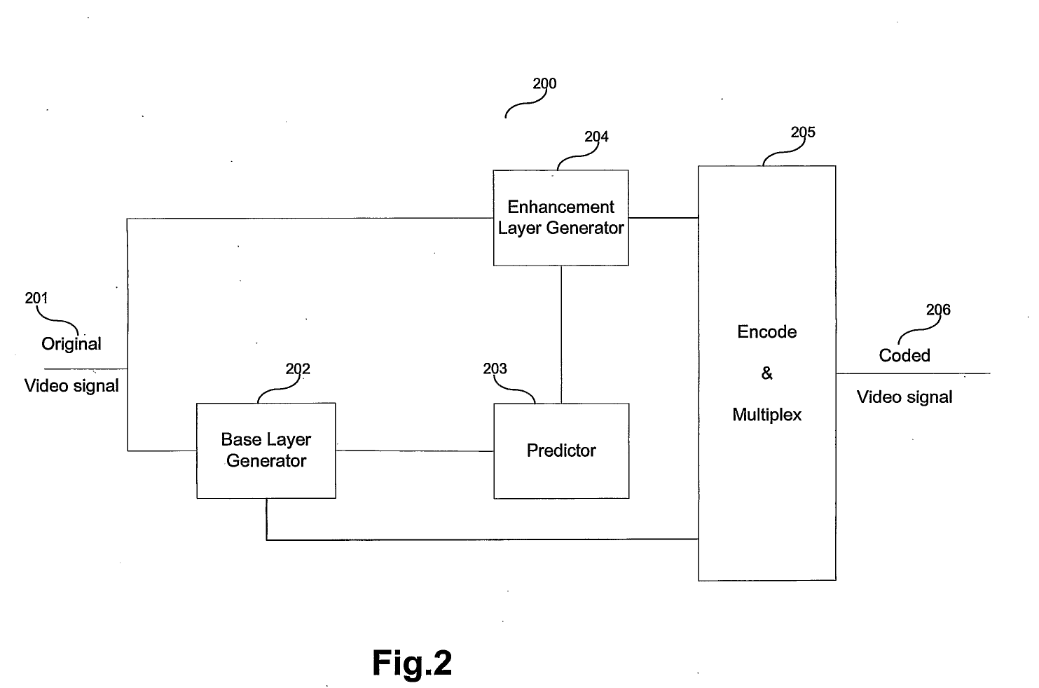

FIG. 2 shows an encoder 200 according to an embodiment of the invention.

The original video signal 201 to be coded is fed (in slices) to a base layer generator 202. The base layer generator generates a base layer (i.e. base layer coding information) which is fed into a predictor 203. The predictor 203 predicts the original video signal based on the base layer. From the prediction generated by the predictor 203 and the original video signal 201, an enhancement layer generator 204 generates an enhancement layer (i.e. enhancement layer coding information).

The enhancement layer and the base layer are then encoded and multiplexed by an encoding and multiplexing unit 205 such that a coded video signal 206 corresponding to the original video signal 201 is formed.

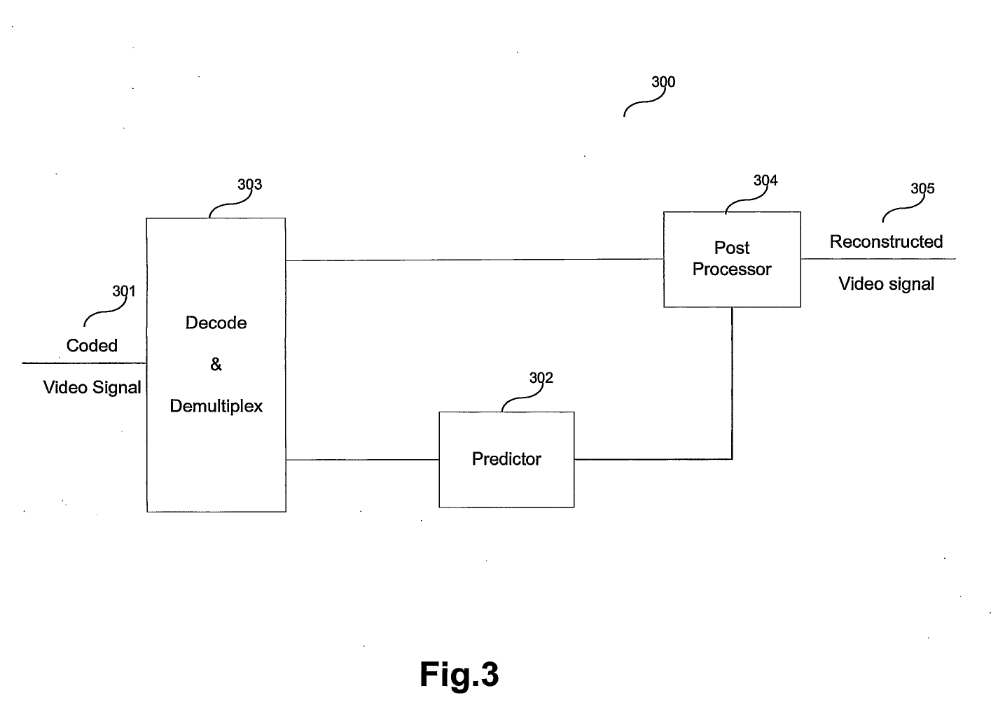

A decoder corresponding to the encoder 200 is shown in FIG. 3.

FIG. 3 shows a decoder 300 according to an embodiment of the invention.

A coded video signal 301 corresponding to the coded video signal 206 generated by the encoder 200 is fed (in slices) to a decoding and demultiplexing unit 303. The decoding and demultiplexing unit 303 extracts the base layer (i.e. base layer coding information) and the enhancement layer (i.e. enhancement layer coding information) from the coded video signal 301. The base layer is fed to a predictor 302 which generates a prediction from the base layer.

The prediction and the enhancement layer are fed to a post processor 304 generating a reconstructed video signal 305 corresponding to the original video signal 201.

The encoder 200 and the decoder 300 are for example adapted to function according to the MPEG (Moving Pictures Expert Group) standard or according to the H.264 standard (except for the additional features according to the invention).

Although the encoder 200 and the decoder 300 have been explained in the case that for each slice at the enhancement layer, there is one base layer, the encoder 200 can be used in different modes, in particular in modes where the predictor 203 receives more than one base layers as input and calculates a prediction form these more than one base layers. For simplicity, the following is explained in the context of the encoder 200. The decoder 300 has the corresponding functionality.

For each slice at the “enhancement layer”, there are possibly two base layers that are for example labeled by base-layer-id1-plus1 and base-layer-id2-plus1, respectively.

In the following explanation, the layers denoted by (QCIF,Low), (QCIF, Medium), (CIF, Low) and (CIF, Medium) already mentioned above are used.

As mentioned above, “Low” indicates that the corresponding layer comprises coding information quantized with an accuracy lower than a layer with corresponding to “Medium”. “QCIF” indicates that the corresponding layer comprises coding information for a lower spatial resolution than a layer corresponding to “CIF”.

If there is no “base layer” for the current “enhancement layer”, for example, (QCIF, Low), both of the parameters base-layer-id1-plus1 and base-layer-id2-plus1 are −1. If there is only one base layer for the current enhancement layer, for example, (CIF, Low) and (QCIF, Medium), base-layer-id1-plus1 refers to (QCIF, Low) and base-layer-id2-plus1 is −1. If there are two base layers for the current enhancement layer, for example, (CIF, Medium), base-layer-id1-plus1 refers to (QCIF, Medium) and base-layer-id2-plus1 refers to (CIF, Low). Therefore, there may be three modes for the inter-layer prediction of (CIF, Medium) carried out by the predictor 203:

Mode 1: Predict from (CIF, Low) (i.e. use (CIF, Low) as base layer)
Mode 2: Predict from (QCIF, Medium) (i.e. use (QCIF, Medium) as base layer)
Mode 3: Predict from both (CIF, Low) and (QCIF, Medium) (i.e. use (CIF, Low) and (QCIF, Medium) as base layers).

Modes 1 and 2 are carried out as described in [1] and [3].

A mathematical description of mode 3 is given in the following.

Suppose that the reference frames are

$${\tilde{A}}_{2 n} ( \frac{x}{2} , \frac{y}{2} )$$

and A₂ₙ(x, y) at the resolutions of QCIF and CIF, respectively, and the low quality and the medium quality correspond to two quantization parameters QP₁ and QP₂, respectively. Let (dx₀, dy₀) denote the motion information that is generated for (QCIF, Low). For simplicity, let D(1,1,2n, 2n+1,x, y, dx₀, dy₀) and D(1,2,2n, 2n+1,x, y, dx₀, dy₀) denote the residual information that is coded at (QCIF, Low) and (QCIF, Medium), respectively. Mathematically, they are given by

D(1,1,2n, 2n+1,x,y, dx₀, dy₀)=S_{D}(A₂ₙ₊₁(x,y))−Ã₂ₙ(x/2−dx₀,y/2−dy₀),

### for (QCIF,Low) and

D(1,2,2n,2n+1,x,y,dx₀,dy₀)=D(1,1,2n,2n+1,x,y, dx₀,dy₀)−IQ_{QP}_{₁}(Q_{QP}_{₁}(D(1,1,2n,2n+1,x,y,dx₀,dy₀))). (1)

### for (QCIF, Medium)

where S_{D} denotes a down-sampling operation (see [1], [3]).

The residual information that will be coded at (CIF, Medium) when mode 3 is used is then given by

\tilde{D}(2,2n,2n+1,x,y,dx,dy,dx₀,dy₀)=\hat{D}ₛᵣ(2,2n,2n+1,x,y,dx,dy,dx₀,dy₀,QP₂,i,j)−IQ_{QP}_{₁}(Q_{QP}_{₁}(\hat{D}ₛᵣ(1, 2n, 2n+1,x,y,dx,dy,dx₀, dy₀,QP₁,i,j))), (2)

where (dx, dy) is the motion information at the resolution of CIF, and

$${\hat{D}}_{sr} ( \begin{matrix}1 , 2 n , 2 n + 1 , x , y , dx , \\ dy , {dx}_{0} , {dy}_{0} , {QP}_{1} , i , j\end{matrix} ) = D ( \begin{matrix}2 , 1 , 2 n , n + \\ 1 , x , y , dx , dy\end{matrix} ) \\ - i * \frac{{S}_{U} {\sum }_{k = 1}^{1} {IQ}_{{QP}_{k}} ( {Q}_{{QP}_{k}} ( D ( 1 , k , 2 n , 2 n + 1 , x , y , {dx}_{0} , {dy}_{0} ) ) ) )}{{2}^{j}} \\ ( i , j ) ∈ \{ ( 0 , 0 ) , ( 1 , 0 ) \} , 1 = 1 , 2 , \\ D ( \begin{matrix}2 , 1 , 2 n , 2 n + \\ 1 , x , y , dx , dy\end{matrix} ) = {A}_{2 n + 1} ( x , y ) - {A}_{2 n} ( x - dx , y - dy ) . \qquad ( 3 )$$

where S_{U} denotes an up-sampling operation (see [1], [3]), Q_{QP}_{ₖ} denotes a quantization operation with quantization parameter QPₖ and IQ_{QP}_{ₖ} denotes the corresponding inverse quantization operation.

The value of (i, j) is chosen adaptively to minimize the remaining residual information at higher resolution.

Equation (1) is adopted to remove the SNR (signal-to-ratio) redundancy between (QCIF, Low) and (QCIF, Medium). Equation (2) is used to remove the SNR redundancy between (CIF, Low) and (CIF, Medium). Equation (3) is applied to remove the spatial redundancy between (CIF, Low) and (QCIF, Low), and that between (CIF, Medium) and (QCIF, Medium).

When two successive layers denoted by layer 1 and layer 2 are used, wherein layer 1 is truncated from layer 2 by the SNR truncation scheme described in [3], two different SNR truncation schemes on the partitioning of an MB at layer 1 can be used.

One SNR truncation scheme is that the partitioning of an MB is non-scalable. In other words, both the MB type (MB_type) and the sub-MB type (Sub_MB_type) of an MB at layer 1 are the same as those of the same MB at layer 2. Intra texture prediction using information from layer 1 can always be performed for all Intra MBs at layer 2. The MB_type and Sub_MB_type are coded at layer 1 and do not need to be coded at layer 2.

The other SNR truncation scheme is that the partitioning of an MB is a coarsed one of that at layer 2, the relationship between the MB_type and the Sub_MB_type of an MB at layer 1 and those of the co-located MB at layer 2 are listed in Tables 1 and 2, respectively.

TABLE 1
Relationship between the MB_type of an MB at
layer 1 and that of the co-located MB at layer 2

| MB_type at layer 2 | MB_type at layer 1 |
|---|---|
| 16 × 16 | 16 × 16 |
| 16 × 8 | 16 × 16, 16 × 8 |
| 8 × 16 | 16 × 16, 8 × 16 |
| 8 × 8 | 16 × 16, 8 × 16, 16 × 8, 8 × 8 |

TABLE 2
Relationship between the Sub_MB_type of an MB
at layer 1and that of the collocated MB at layer 2

| Sub_MB_type at layer 2 | Sub_MB_type at layer 1 |
|---|---|
| 8 × 8 | 8 × 8 |
| 8 × 4 | 8 × 8, 8 × 4 |
| 4 × 8 | 8 × 8, 4 × 8 |
| 4 × 4 | 8 × 8, 4 × 8, 8 × 4, 4 × 4 |

Now, let layer 1 and layer 2 be two successive layers where layer 1 is truncated from layer 2 by the spatial truncation scheme described in [3]. For any Macroblock (MB) at layer 1, the four co-located Macroblocks at layer 2 are identified. Two different spatial truncation schemes can be used on the partitioning of an MB at layer 1.

A macroblock is a fixed-size area of an image on which motion compensation is based. Illustratively, a plurality of pixels (for example the pixels of a 8×8 rectangle) are grouped to a macroblock.

One spatial truncation scheme is that the MB_types of four, MBs at layer 2 are totally derived from the MB_type and the Sub_MB_type of the co-located MB at layer 1, i.e. they do not need to be coded at layer 2. Intra texture prediction using information from layer 1 can always be performed for all Intra MBs at layer 2. The MB_type and Sub_MB_type of an MB at layer 1 are derived according to the following two cases:

Case 1 Among the four co-located MBs, there is one MB with MB_type not as 16×16. The MB_type is 8×8 and the Sub_MB_type is determined by the MB_type of the corresponding MBs at layer 2. The Sub_MB_type and the initial MVs are given in Table 3.

TABLE 3
The Sub_MB_type and the initial MVs at layer 1.

| | Sub_MB_type (also the | |
|---|---|---|
| MB_type at | auxiliary Sub_MB_type) | Initial MVs at |
| layer 2 | at layer 1 | layer 1 |
| 16 × 16 | 8 × 8 | Divided the MV at |
| | | layer 2 by 2. |
| 16 × 8 | 8 × 4 | Divided the MVs at |
| | | layer 2 by 2. |
| 8 × 16 | 4 × 8 | Divided the MVs at |
| | | layer 2 by 2. |
| 8 × 8 | 4 × 4 | Divided the MVs of |
| | | the upper-left |
| | | blocks by 2. |

Case 2 The MB_types of the four co-located MBs at layer 2 are 16×16. The initial value of MB_type at layer 2 is set as 8×8, and four MVs are derived by dividing the MVs of the four co-located MBs at layer 2 by 2. The final MB_type and MVs are determined by the RDO with constraints on the truncation of MVs.

The other spatial truncation scheme is the MB_types of four MBs at layer 2 cannot be determined by the MB-type and the Sub_MB_type of the co-located MB at layer 1. An auxiliary MB_type is set as 8×8 for the MB at layer 1 and an auxiliary Sub_MB_type is set for each sub-MB at layer 1 according to the MB_type of the corresponding MB at layer 2. Similarly to the SNR scalability, the relationship between the actual MB_type and Sub_MB_type and the auxiliary ones are listed in Tables 4 and 5, respectively.

TABLE 4
Relationship between auxiliary and actual MB_type at layer 1

| Auxiliary MB_type at layer 1 | Actual MB_type at layer 1 |
|---|---|
| 8 × 8 | 16 × 16, 8 × 16, 16 × 8, 8 × 8 |

TABLE 5
Relationship between auxiliary and
actual Sub_MB_type at layer 1

| Auxiliary Sub_MB_type at layer 1 | Actual Sub_MB_type at layer 1 |
|---|---|
| 8 × 8 | 8 × 8 |
| 8 × 4 | 8 × 8, 8 × 4 |
| 4 × 8 | 8 × 8, 4 × 8 |
| 4 × 4 | 8 × 8, 4 × 8, 8 × 4, 4 × 4 |

Context Adaptive Binary Arithmetic Coding (CABAC) already adopted in MPEG-4 AVC [2] is also used for entropy coding in current Working draft ([1]). The only difference between them is that the current working draft has additional context models for additional syntax elements and FGS coding. In order to improve coding efficiency, CABAC uses various context models for each syntax element. The context modeling makes it possible to estimate more accurate probability model for binary symbols of syntax elements by using syntax elements at neighboring blocks.

Meanwhile, there are two independent motion vector fields (MVFs) in the former case while there is only one motion vector field in the latter case. The statistics of the SNR/spatial refinement scheme and the SNR/spatial truncation scheme are usually different, different context models are used according to one embodiment of the invention. Thus, a bit is sent from the encoder to the decoder for layer 1 to specify whether layer 1 is truncated from layer 2 or not. The bit of 1 means layer 1 is truncated from layer 2, and 0 implies that layer 1 is not truncated from layer 2. This bit is included in the slice header.

In the current working draft (WD 1.0, [1]), for encoding the motion field of an enhancement layer, two macroblock (MB) modes are possible in addition to the modes applicable in the base layer: “BASE_LAYER_MODE” and “QPEL_REFINEMENT_MODE”. When the “BASE_LAYER_MODE” is used and no further information is transmitted for the corresponding macroblock. This MB mode indicates that the motion/prediction information including the MB partitioning of the corresponding MB of the “base layer” is used. When the base layer represents a layer with half the spatial resolution, the motion vector field including the MB partitioning is scaled accordingly. The “QPEL_REFINEMENT_MODE” is used only if the base layer represents a layer with half the spatial resolution of the current layer. The “QPEL_REFINEMENT_MODE” is similar to the “BASE_LAYER_MODE”. The MB partitioning as well as the reference indices and motion vectors (MVs) are derived as for the “BASE_LAYER_MODE”. However, for each MV a quarter-sample MV refinement (−1, 0, or +1 for each MV component) is additionally transmitted and added to the derived MVs.

Therefore, in one embodiment, a new mode “NEIGHBORHOOD_REFINEMENT_MODE”, which means that the motion/prediction information including the MB partitioning of the corresponding MB of its “base layer” is used and the MV of a block at the enhancement layer is in a neighborhood of that of the corresponding block at its “base layers”. Same as “QPEL_REFINEMENT_MODE”, a refinement information is additional transmitted. Our “NEIGHBORHOOD_REFINEMENT_MODE” is applicable to both SNR scalability and spatial scalability.

Suppose the motion vector (MV) of a block at the “base layer” is (dx₀, dy₀). When the SNR scalability is considered, the center of the neighborhood is (dx₀, dy₀). When the spatial scalability is studied, the center of the neighborhood is (2dx₀, 2dy₀). Same as “QPEL_REFINEMENT_MODE”, a refinement information is additional transmitted. The “NEIGHBORHOOD_REFINEMENT_MODE” is applicable to both SNR scalability and spatial scalability. The new mode is in one embodiment designed by also taking the SNR/spatial truncation scheme described in [3] into consideration.

Assume that quantization parameters for the generation of motion vectors at the base layer and the enhancement layer are QP_{b} and QPₑ, respectively. Normally, the size of neighborhood is adaptive to QP_{b} and QPₑ, and is usually a monotonic non-decreasing function of |QPₑ−QP_{b}|. The choice of refinement information depends on the size of the neighborhood. An example is given in the following.

When |QPₑ−QP_{b}| is greater than a threshold, the size of neighborhood and the choice of refinement information for the SNR truncation scheme and the spatial truncation scheme are listed in Tables 6 and 7, respectively.

TABLE 6
Neighborhood for the SNR truncation

| MV at the base layer | The possible choices of refinement |
|---|---|
| Full Pixel | {−1, −½, −¼, 0, ¼, ½, 1} |
| Half Pixel | {−¼, 0, ¼) |

TABLE 7
Neighborhood for the spatial truncation Similar to the
“QPEL_REFINEMENT_MODE” described in WD 1.0
([1]), the mapping between the refinement information
and the integers is predefined (see Table 8).

| MV at the base layer | The possible choices of refinement |
|---|---|
| Full Pixel | {−1, −½, −¼, 0, ¼, ½, 1} |
| Half Pixel | {−½, −¼, 0, ¼, ½} |
| Quarter Pixel | {−¼, 0, ¼} |

TABLE 8
The mapping for SNR/spatial truncation

| Refinement | | | | | | | |
|---|---|---|---|---|---|---|---|
| information | −1 | −½ | −¼ | 0 | ¼ | ½ | 1 |
| Integers | −4 | −2 | −1 | 0 | 1 | 2 | 4 |

In this document, the following publications are cited:
[1] Julien Reichel, Heiko Schwarz and Mathias Wien. Working Draft 1.0 of 14496-10:200x/AMD 1 Scalable Video Coding, ISO/IEC JTC1/SC29 WG11 MPEG2005/N6901, Kong Hong, China. January 2005.
[2] Information Technology-Coding of Audio-Visual Objects-Part 10: Advance Video Coding. ISO/IEC FDIS 14496-10.
[3] Z. G. Li, X. K. Yang, K. P. Lim, X. Lin, S. Rahardja and F. Pan. Customer Oriented Scalable Video Coding. ISO/IEC JTC1/SC29 WG11 MPEG2004/M11187, Spain, October 2004.

1. Method for encoding at least one digital picture, wherein
a first representation of the picture is generated
a second representation of the picture is generated
a third representation of the picture is generated from the first representation of the picture and the second representation of the picture by predicting the coding information being assigned to picture elements of the picture using the first representation of the picture and the second representation of the picture.

2. Method according to claim 1, wherein the second representation of the picture is generated such that it has a lower signal-to-noise ratio than the first representation.

3. Method according to claim 2, wherein the second representation of the picture is generated such that it has a higher resolution than the first representation.

4. Method according to claim 1, wherein the second representation is generated such that it has the resolution according to the CIF.

5. Method according to claim 1, wherein the first representation is generated such that it has the resolution according to the QCIF.

6. Method according to claim 1, wherein the third representation is generated such that it has the resolution according to the CIF.

7. Encoder for encoding at least one digital picture, wherein the encoder comprises
a first generation unit adapted to generate a first representation of the picture
a second generation unit adapted to generate a second representation of the picture
a third generation unit adapted to generate a third representation of the picture from the first representation of the picture and the second representation of the picture by predicting the coding information of the picture elements of the picture using the first representation of the picture and the second representation of the picture.

8. A computer program product, which, when executed by a computer, makes the computer perform a method for encoding at least one digital picture, wherein
a first representation of the picture is generated
a second representation of the picture is generated
a third representation of the picture is generated from the first representation of the picture and the second representation of the picture by predicting the coding information of the picture elements of the picture using the first representation of the picture and the second representation of the picture.
